(19) United States
(12) Patent Application Publication
(10) Pub. No.: US 2026/0336850 A1
(43) Pub. Date: Oct. 29, 2026

(54) Adaptive Container Packaging Assembly

(71) Applicant: JLS Automation, York, PA (US)

(72) Inventor: Gary Pickett, Indian Trail, NC (US)

(73) Assignee: JLS Automation, York, PA (US)

(21) Appl. No.: 19/193,120

(22) Filed: Apr. 29, 2025

(51) Int. Cl. B65B 43/26; B31B 50/44; B65B 43/10; B65B 43/12; B65B 43/14; B65B 43/18

(52) U.S. Cl. CPC B65B 43/265; B31B 50/44; B65B 43/10; B65B 43/126; B65B 43/145; B65B 43/185; B65B 2210/04

(57) ABSTRACT

The adaptive container packaging assembly includes a container forming assembly, the container forming assembly includes a main frame, the main frame houses a magazine. The magazine includes a plurality of blanks. The adaptive container packaging assembly further includes a transferring mechanism coupled to the main frame. The container packaging assembly further includes a blank transport assembly positioned along a width of the main frame, wherein the transferring mechanism transports a blank from the plurality of blanks in the magazine to the blank transport assembly, the transferring mechanism positions the blank perpendicular to the blank transport assembly, the transferring mechanism positions the blank perpendicular to the flow direction of the magazine for transport downstream to a forming station. The assembly further includes a container shuttle assembly with a guideway and adjustable transport vehicles configured to handle varying container sizes using automatic size adjustment and variable pitch features. A product transport assembly loads products into containers, and a positioning management system synchronizes the container forming assembly, container shuttle assembly, and product transport assembly to efficiently package products in containers of different sizes concurrently.

### FIELD OF THE INVENTION

The invention relates to a container packaging assembly and, more particularly, to an adaptive container packaging assembly for forming and loading varying sized containers using a container shuttle assembly.

### BACKGROUND

Product packaging for food provides protection, tampering resistance, and product information of processed food before it is delivered to the consumer.

A container, which is typically used for packaging, is generally made of chip board or paper board, but is not limited to these materials. Examples of this type of container are cereal boxes, boxes of snack cakes, and boxes containing a frozen food meal. These containers are usually made by a container forming machine that produces one or more sized containers that are stored and then sent downstream to be loaded.

There are many known techniques for loading containers for food packaging including the following two main packaging methods for cartoning: (1) load the product into the container through the side or end of the container, and (2) load the product through the top of the container. These containers are usually made by a machine producing one size at a time that is stored and then sent downstream to be packaged by a loading assembly that is designed to handle only one container size at a time. However, known loading assemblies require manual adjustments or separate machines to handle different container sizes, leading to downtime and inefficiency. There is a need to efficiently form and load varying size containers using a unitary assembly without downtime to adjust the machine performing forming and loading of the containers. Prior art systems, such as those described in U.S. Pat. Nos. 5,123,231 and 6,789,123, rely on fixed-size loading mechanisms or manual changeovers, which are time-consuming and limit flexibility.

### SUMMARY

The adaptive container packaging assembly includes a container forming assembly, the container forming assembly includes a main frame, the main frame houses a magazine. The magazine includes a plurality of blanks. The adaptive container packaging assembly further includes a transferring mechanism coupled to the main frame. The container packaging assembly further includes a blank transport assembly positioned along a width of the main frame, wherein the transferring mechanism transports a blank from the plurality of blanks in the magazine to the blank transport assembly, the transferring mechanism positions the blank perpendicular to the blank transport assembly, the transferring mechanism positions the blank perpendicular to the flow direction of the magazine for transport downstream to a forming station. The assembly further includes a container shuttle assembly with a guideway and adjustable transport vehicles configured to handle varying container sizes using automatic size adjustment and variable pitch features. A product transport assembly loads products into containers, and a positioning management system synchronizes the container forming assembly, container shuttle assembly, and product transport assembly to efficiently package products in containers of different sizes concurrently.

### BRIEF DESCRIPTION OF DRAWINGS

In the following, the present invention is described in more detail with references to the drawings in which:

FIG. 1 illustrates a perspective view of a container packaging assembly according to the invention; showing the major components, including the container forming assembly, container shuttle assembly, and product transport assembly, without protective housing (H) and structural supports(S) thereof.

FIG. 2 illustrates a front, partial perspective view of the container packaging assembly of FIG. 1, showing the magazine and transferring mechanism of the container forming assembly.

FIG. 3 illustrates a front, partial perspective view of the container packaging assembly of FIG. 2, showing the blank transport assembly and constructing assembly.

FIG. 4 illustrates a rear, partial perspective view of the container packaging assembly of FIG. 3, showing the adhesive assembly and its interaction with the blank.

FIG. 5 illustrates a front, partial perspective view of the container packaging assembly of FIG. 4, showing the transfer of a blank to the container shuttle assembly.

FIG. 6 illustrates an enlarged partial perspective view of the container packaging assembly, showing the transferring mechanism's vacuum element engaging a blank.

FIG. 7 illustrates an enlarged partial perspective view of the container packaging assembly, showing the robot arm and end effector of the constructing assembly.

FIG. 8 illustrates an enlarged partial perspective view of the container packaging assembly, showing the adhesive distribution members applying adhesive to a blank.

FIG. 9 illustrates an enlarged partial perspective view of the container packaging assembly, showing the positioning of a formed container on the container shuttle assembly.

FIG. 10 is a perspective view of a container shuttle assembly according to the invention, including the guideway, transport vehicles, and unloading assembly.

FIG. 11 is a front view of the container shuttle assembly of FIG. 10, showing the frame assembly and adjustable shuttles.

FIG. 12 is a close-up perspective view of the container shuttle assembly of FIG. 10, showing the linear synchronous motor (LSM) drive modules.

FIG. 13 is a close-up front perspective view of a guideway of container shuttle assembly of FIG. 10, showing the guide rails and propulsion coils.

FIG. 14 is a close-up rear perspective view of a guideway of container shuttle assembly of FIG. 10, showing the guide rail brackets and drive module connections.

FIG. 15 is a perspective view of a plurality of transport vehicles of a container shuttle assembly according to the invention, showing the leading and trailing shuttles.

FIG. 16 is a bottom view of the plurality of transport vehicles of FIG. 15, showing the magnet and guide rollers.

FIG. 17 is a top view of the plurality of transport vehicles of FIG. 15, showing the carrier assembly and holding block.

FIG. 18 is a top perspective view of a transport vehicle of a container shuttle assembly according to the invention, showing the first and second carrier sections.

FIG. 19 is a bottom perspective view of the transport vehicle of FIG. 18, showing the roller connection members and magnet receiving space.

FIG. 20 is a partial front view of the container packaging assembly, showing the product transport assembly loading product into a container.

FIG. 21 is a top view of the partial container shuttle assembly according to the invention, illustrating the variable pitch feature with varying distances between containers.

### DETAILED DESCRIPTION OF THE EMBODIMENTS

Exemplary embodiments of the present invention will be described hereinafter in detail with reference to the attached drawings, wherein like reference numerals refer to like elements. The present invention may, however, be embodied in many different forms and should not be construed as being limited to the embodiments set forth herein; rather, these embodiments are provided so that the present disclosure will be thorough and complete, and will fully convey the concept of the disclosure to those skilled in the art.

Now with reference to the figures, an adaptive container packaging assembly 1 (“container packaging assembly 1”) according to the invention is shown.

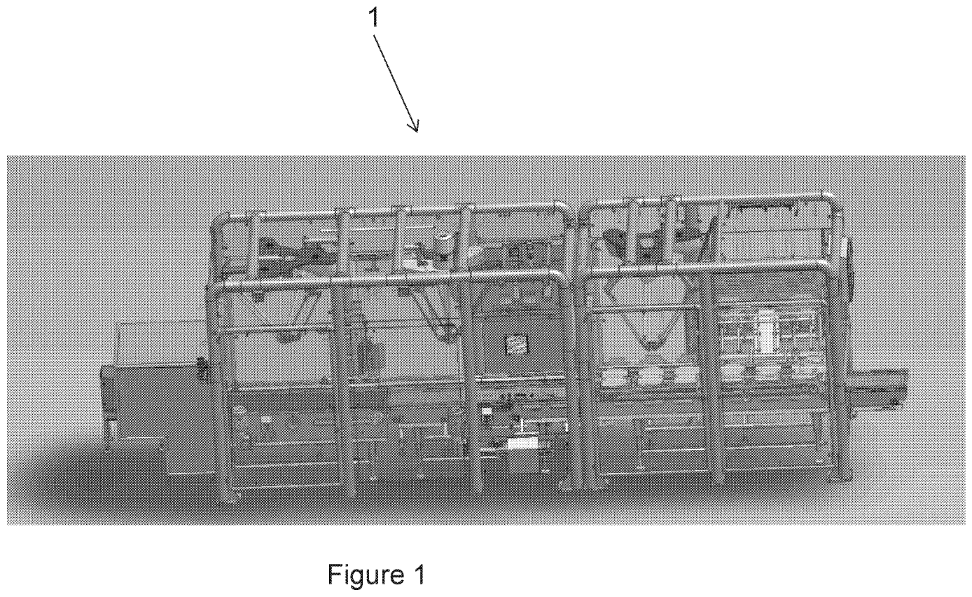

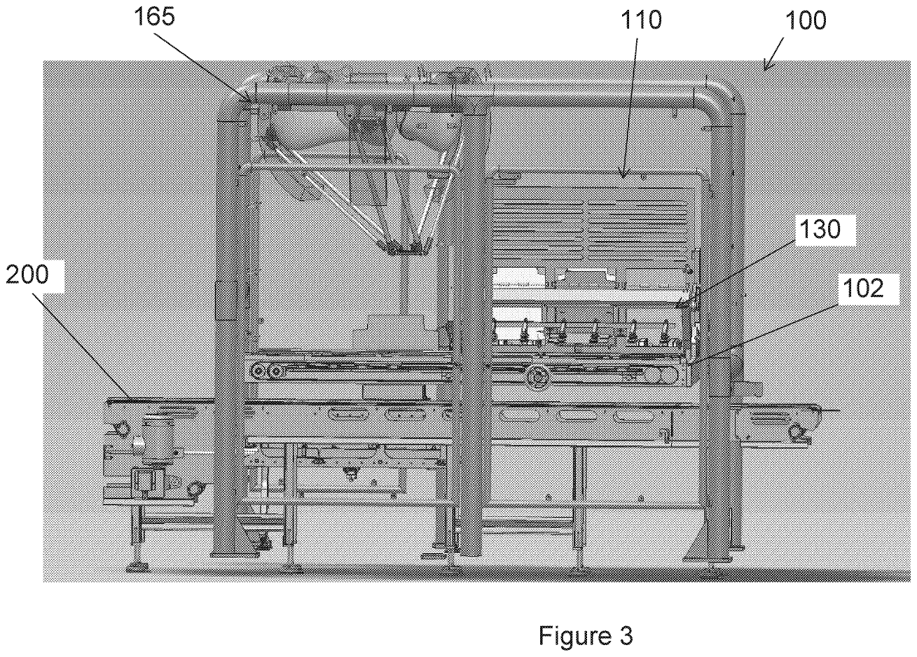

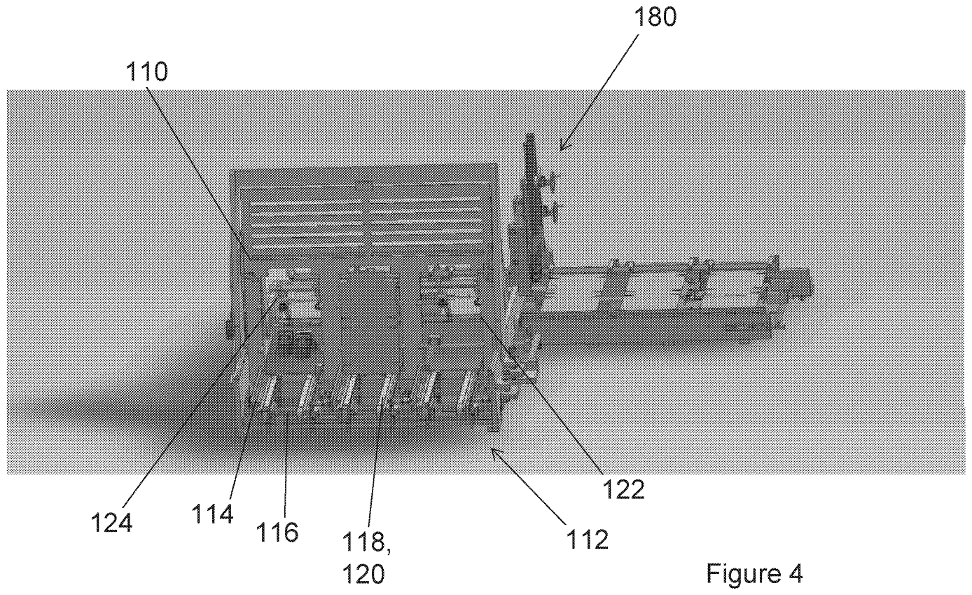

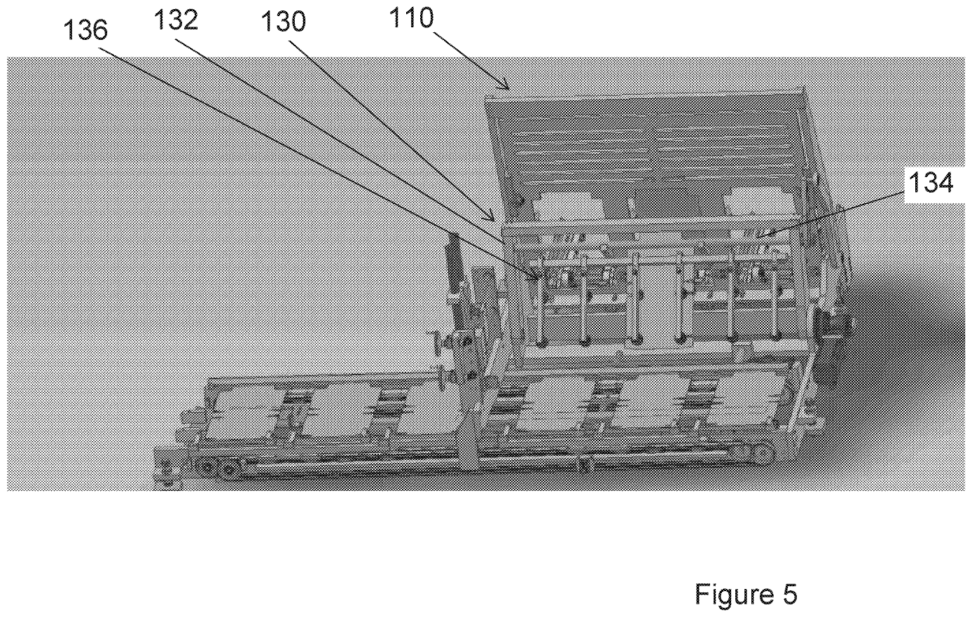

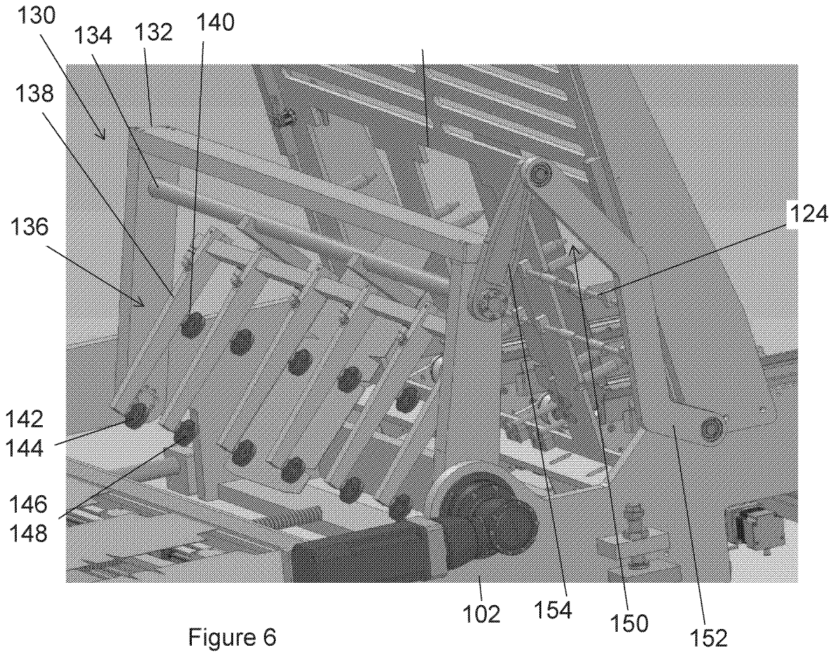

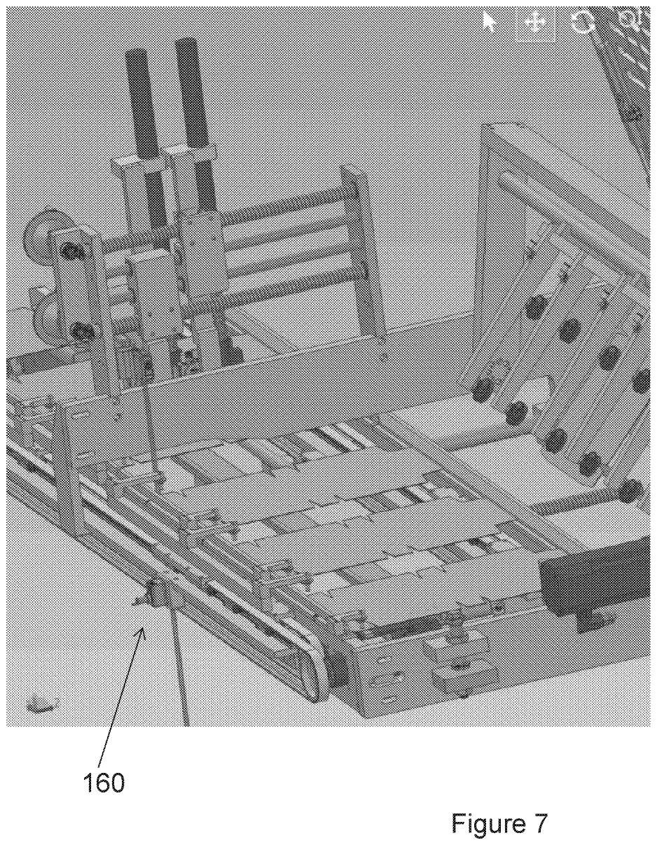

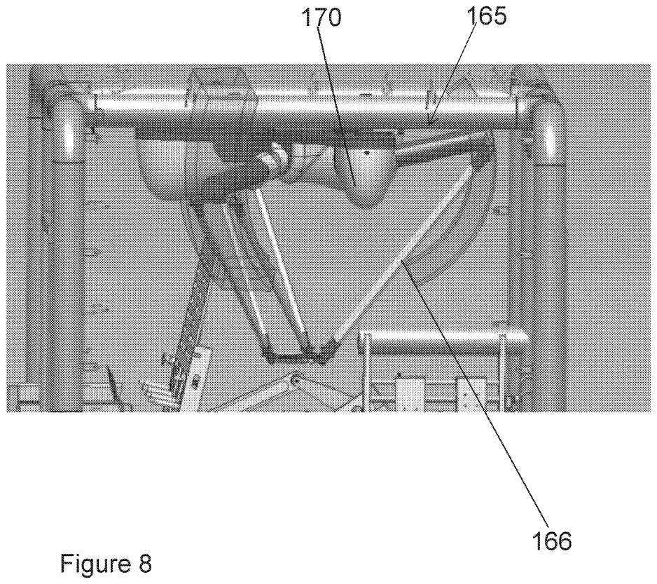

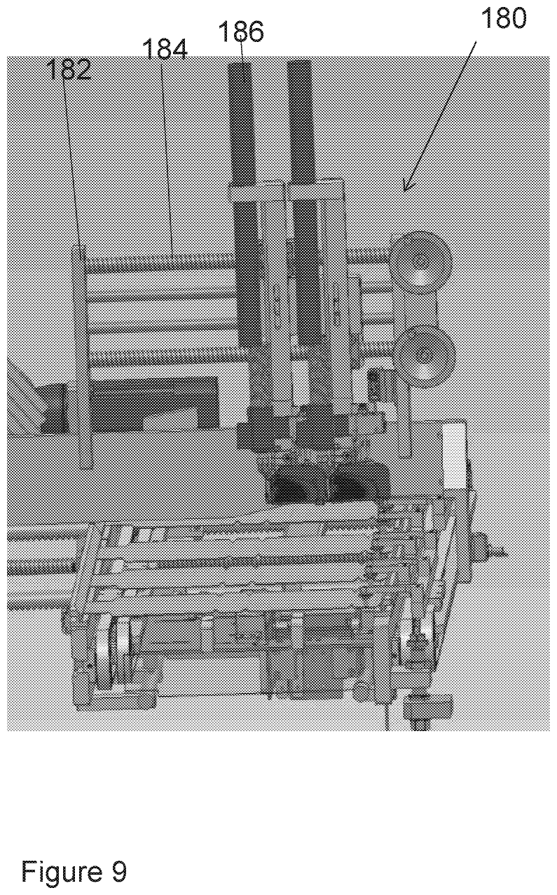

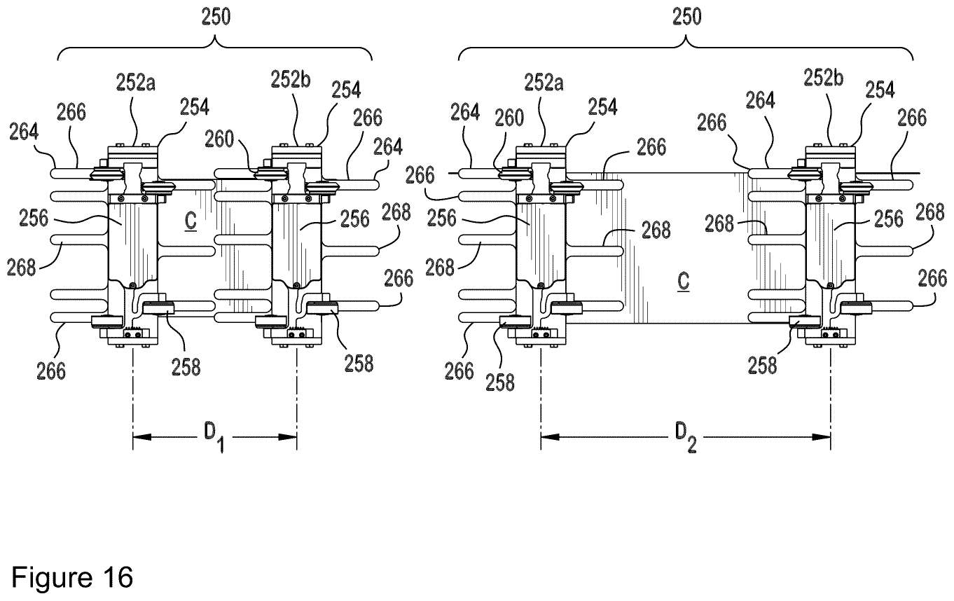

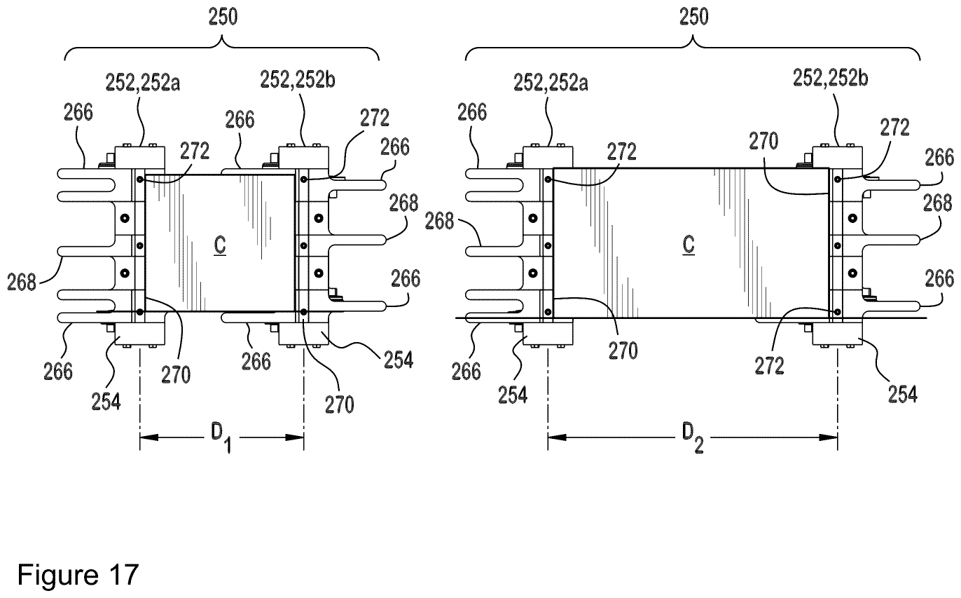

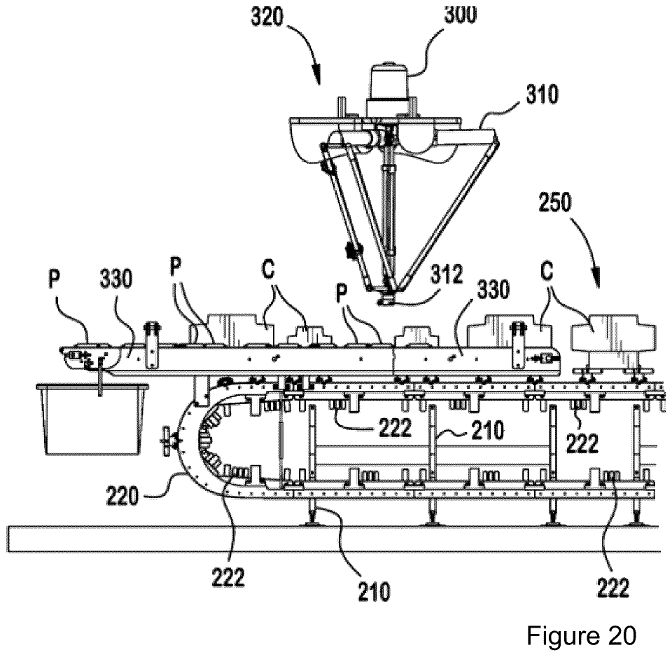

As shown in FIG. 1-21, the container packaging assembly 1 according to the invention generally includes a container forming assembly 100, a container shuttle assembly 200, a product transport assembly 300, and a positioning management system 400. For purposes of detail and clarity, FIG. 1-21 do not include the protective housing (H) and structural supports(S) shown in FIG. 1, in order to view the following major components of the present invention. One skilled in the art should appreciate that the protective housing (H) and structural supports(S) are used known to the art and are used to generally protect and structurally support the major components the present invention.

For purposes of enablement, this description will focus on use of a paper carton as a container C. However, one skilled in the art should appreciate that any container can be used with the container packaging assembly 1 within the spirit of the invention. This would be any known container to hold product to be packaged, including boxes, cans, cartons, totes, cases, or containers made from materials such as plastic, metal, or composites.

### Container Forming Assembly

In the exemplary embodiment, the container forming assembly 100 generally includes a main frame 102. The main frame 102 houses a magazine 110, a transferring mechanism 130, a movement assembly 150, a blank transport assembly 160, a constructing assembly 165, and an adhesive assembly 180.

In the exemplary embodiment, the magazine 110 is positioned within the main frame 102 and generally includes a plurality of cartridges 112. Each cartridge 112 of the plurality cartridges 112 includes a pair of walls 114. The pair of walls 114 provide a channel 116 to hold a plurality of blanks C. A blank C is defined as a flat, unfolded container material, such as a paperboard carton blank. Each cartridge 112 further includes a container transport mechanism 118. The container transport mechanism 118 includes a pair of rotating belts 120 which are positioned along a length of the lower region of the channel 116. The magazine 110 is configured to support a single, double, triple, or quadruple cartridge configuration to handle one to four lanes of blanks simultaneously, with blanks driven forward to carton gates under controlled back pressure for accurate picking.

In the exemplary embodiment, the magazine 110 further includes a placement insert 122. The placement insert 122 corresponds to a shape of the unfolded blank.

In the exemplary embodiment, the magazine 110 further includes a plurality of stabilizing bars 124 extending across each insert 122. Each insert 122 includes at least one stabilizing bar 124. Each stabilizing bar 124 is an elongated member.

In the exemplary embodiment, the transferring mechanism 130 includes an arm 132. The arm 132 extends and is rotatably coupled between a width of the main frame 102. The arm 132 can be u-shaped. One skilled in the art would understand the applicant's design is not the exclusive embodiment. The arm 132 further includes a beam 134.

In the exemplary embodiment, the beam 134 is an elongated member extending across an upper region of the arm 132. The transferring mechanism 130 further includes a plurality of plunger assemblies 136. Each plunger assembly 136 includes a handle member 138. The handle member 138 is hollow and elongated. The handle member 138 further houses at least one vacuum element 140. Each vacuum element 140 comprises a body 142 defining an aperture 144. The aperture 144 is placed in selective communication with a source of negative pressure or vacuum, such as a vacuum pump (not shown) via the illustrated port. The vacuum pump operates at a pressure range of approximately 10 to 100 kPa to ensure reliable blank handling. Sealably attached to an end of the body 142 is a flexible bellows 146.

In the exemplary embodiment, the bellows 146 defines an interior space in fluid communication with the aperture 144. A sealing cup 148 of the bellows 146 defines an open end, and is configured to form an air-tight or sealable connection with the blank to be lifted.

As illustrated, once the sealing cup 148 of the bellows 146 is placed into contact with a surface of the blank, the presence of vacuum pressure within the bellows 146 is operable to create a seal with the blank, and retract the bellows from an extended or resting position, to a contracted or retracted position.

In the exemplary embodiment, the movement assembly 150 includes an upper rotation member 152. The upper rotation member 152 is a beam coupling to the frame 102. The movement assembly 150 further includes a lower rotation member 154. The lower rotation member 154 is a beam coupling to an end of the upper rotation member 152 and the arm 132 of the transferring mechanism 130.

In the exemplary embodiment, the blank transport assembly 160 includes a stationary carton shuttle. The carton shuttle is configured to receive blanks from the transferring mechanism and hold them stationary until captured by servo-driven lugs. The blank transport assembly 160 receives the unformed blank in a direction perpendicular to the flow of the magazine and indexes the blanks downstream to a forming station using four sets of servo-driven lugs that capture the blanks at their corners for precise positioning.

In the exemplary embodiment, the constructing assembly 165 generally includes a robot arm 166 with a plunger end-of-arm tool (EOAT). The robot arm 166 is positioned above the carton shuttle. The robot arm 166 is movable along all three axes of a three-dimensional coordinate system. The plunger EOAT is fixed to an end of the robot arm 166 and is capable of directly interfacing with the blank. The plunger EOAT uses a vacuum to hold the blank and presses it through a forming die to form a tri-seal carton with a base and vertical cover flap, the forming die being interchangeable to accommodate different container sizes. This perpendicular transfer and forming process reduces the number of glue applicators needed to a single set for multiple lanes and improves accessibility for clearing stoppages and changing the forming die.

In the exemplary embodiment, the adhesive assembly 180 includes a pair of stabilizers 182. Each stabilizer 182 is elongated and coupled to the frame 102 collinearly. The adhesive assembly 180 further includes a plurality of beams 184 extending between the pair of stabilizers 182. Each beam 184 of the plurality of beams 184 may be threaded. The adhesive assembly 180 further includes an adhesive cartridge 186 threaded on at least one of the plurality of beams 184. The adhesive assembly 180 further includes a pair of hot melt glue nozzles. The hot melt glue nozzles are coupled to the adhesive cartridge 186. The adhesive cartridge 186 and hot melt glue nozzles rotate between the pair of stabilizers 182 to apply adhesive to major flaps of the blank during indexing to the forming station.

### Container Shuttle Assembly

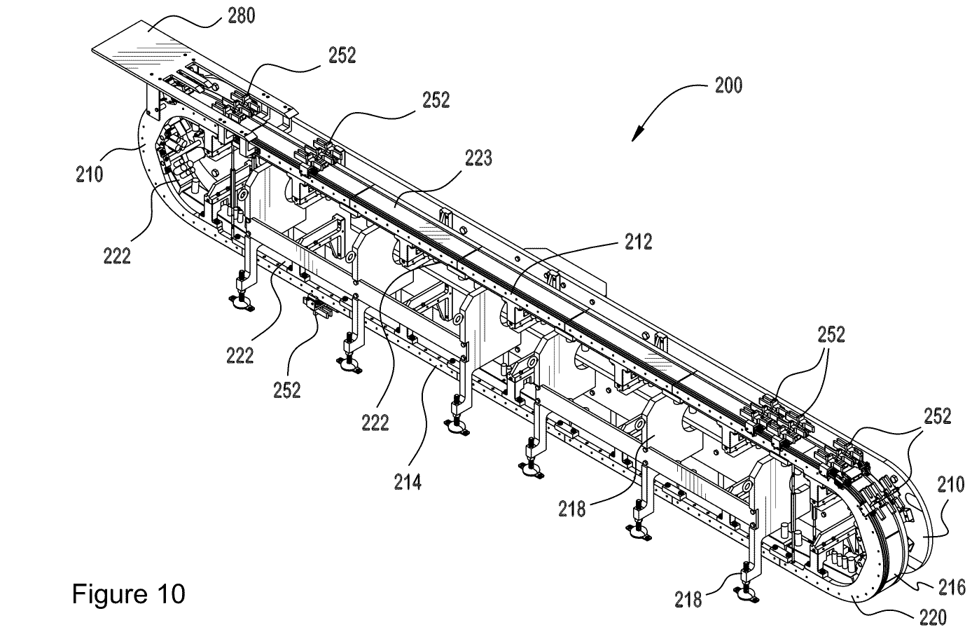

In the exemplary embodiment, a container shuttle assembly 200 according to the invention is shown in FIGS. 10-21. The container shuttle assembly 200 generally includes a frame assembly 210, a linear synchronous motor (LSM) guideway 220 (“guideway 220”), a plurality of transport vehicles 250, and an unloading assembly 280.

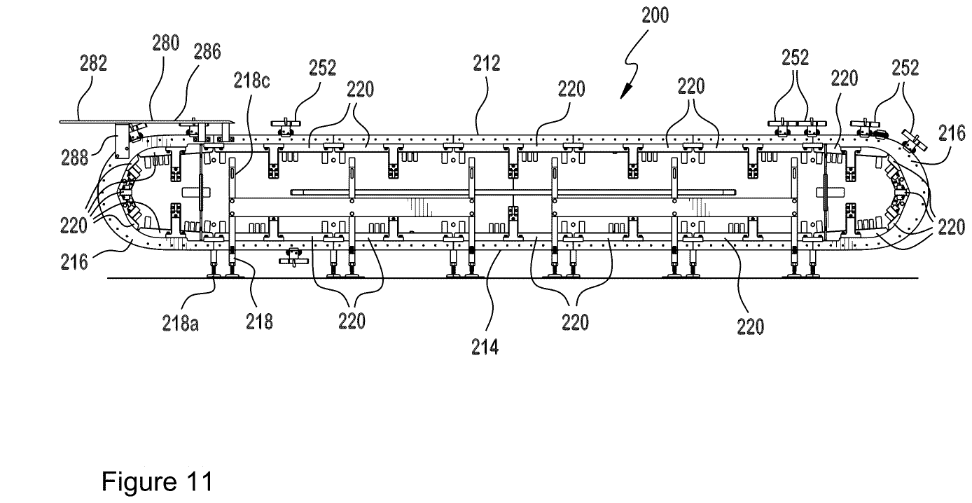

In an exemplary embodiment, a frame assembly 210 according to the invention is shown in FIGS. 10 and 11. The frame assembly 210 generally includes top walls 212, bottom walls 214, side walls 216, and a plurality of support pieces 218.

In the shown embodiment, the frame assembly 210 generally includes a pair of top walls 212 positioned apart and running parallel to each other. Each top wall 212 is a plate-like member made from a rigid material, such as aluminum. Likewise, the frame assembly 210 generally includes a pair of bottom walls 214 positioned apart and running parallel to each other. Each bottom wall 214 is a plate-like member made from a rigid material, such as aluminum. The top walls 212 are spaced apart from and run parallel to the bottom walls 214.

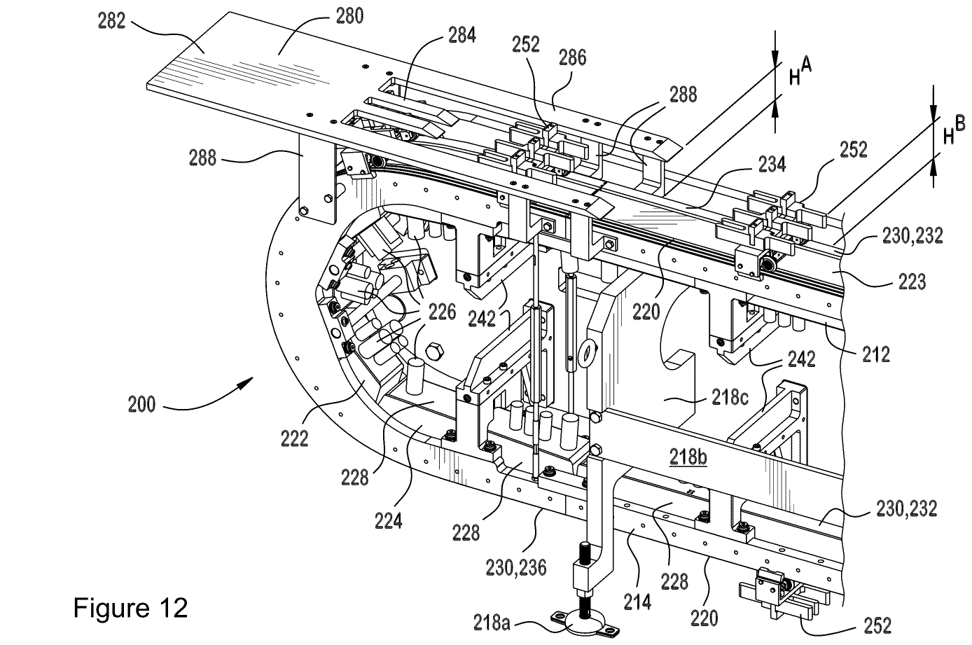

As shown in FIGS. 10 and 11, each end of the frame assembly 210 includes a pair of side walls 216. In the shown embodiment, each side wall 216 is a plate-like member having a C shape (see also FIG. 12). Each pair of side walls 216 are spaced apart from each other and correspond to the top walls 212 and bottom walls 214.

The frame assembly 210 also includes a plurality of support pieces 218 to support the top walls 212, bottom walls 214, and side walls 216 in position and secure them with respect to each other. In the embodiment shown, the top walls 212, bottom walls 214, side walls 216 are positioned to correspond with an oval shape frame or endless loop. In an exemplary embodiment of the invention, the frame assembly 210, more specifically, includes a plurality of floor support pieces 218a, a plurality of wall support pieces 218b, and support brackets 218c.

Now with reference to FIGS. 10-12, an exemplary embodiment of the guideway 220 is shown and generally includes a plurality of drive modules 222, a plurality of guide rails 230, and plurality of guide rail brackets 242.

In an exemplary embodiment, the guideway 220 is a vehicle transport system using a plurality linear synchronous motor (LSM) stators using power to provide a linear force along its length thereof. As shown, the guideway 220 is arranged as a continuous loop with ends creating an oval shaped configuration. The guideway 220 may be of unitary construction, though, as shown in an exemplary embodiment of invention, the guideway 220 is fabricated from a plurality of drive modules 222. The guideway 220 is adapted from LSM systems known in the art, such as those described in U.S. Pat. Nos. 8,074,578 and 8,863,669, which are incorporated by reference, but includes novel features for adaptive container handling as described herein.

Each drive module 222 is a long-stator linear motor section and generally includes a housing 224 enclosing a plurality of propulsion coils 226, as well as position sensing logic (sensors), power electronic components, and microprocessors 228 that serve as controllers for individual drive modules 222. The housing 224 includes a low friction guide surface 223 positioned on a top thereof.

Each drive module 222 may be constructed in the manner of LSM stators known in the art—as adapted in accord with the teachings hereof—and generally in the manner of the guideway described and shown in incorporated-by-reference U.S. Pat. Nos. 8,074,578 and 8,863,669—and as adapted in accord with the teachings here below.

In the shown embodiment, each drive module 222 is positioned in and secured to the frame assembly 210 in a continuous loop, an oval shaped arrangement, as shown.

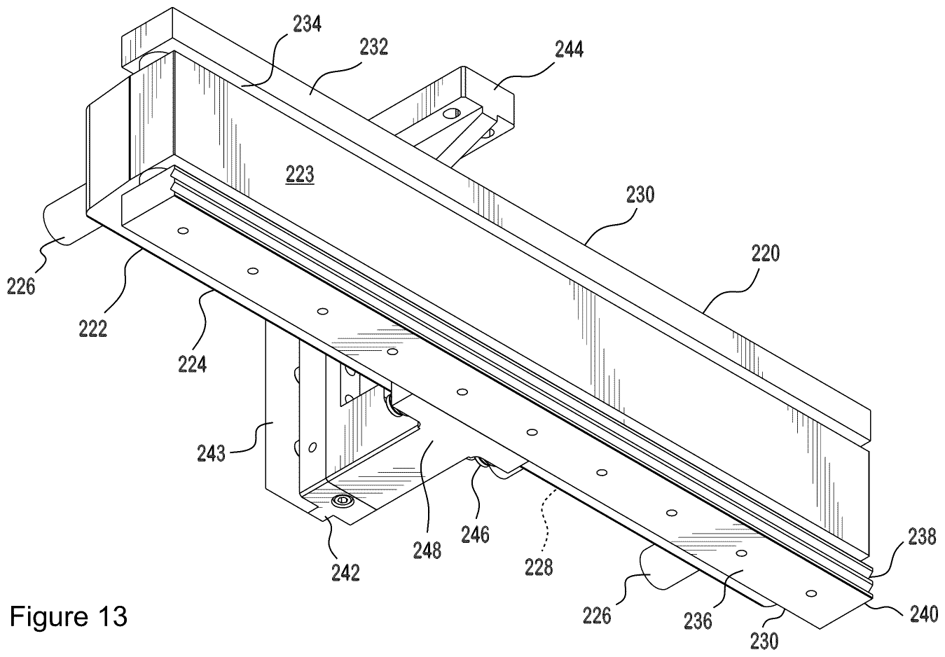

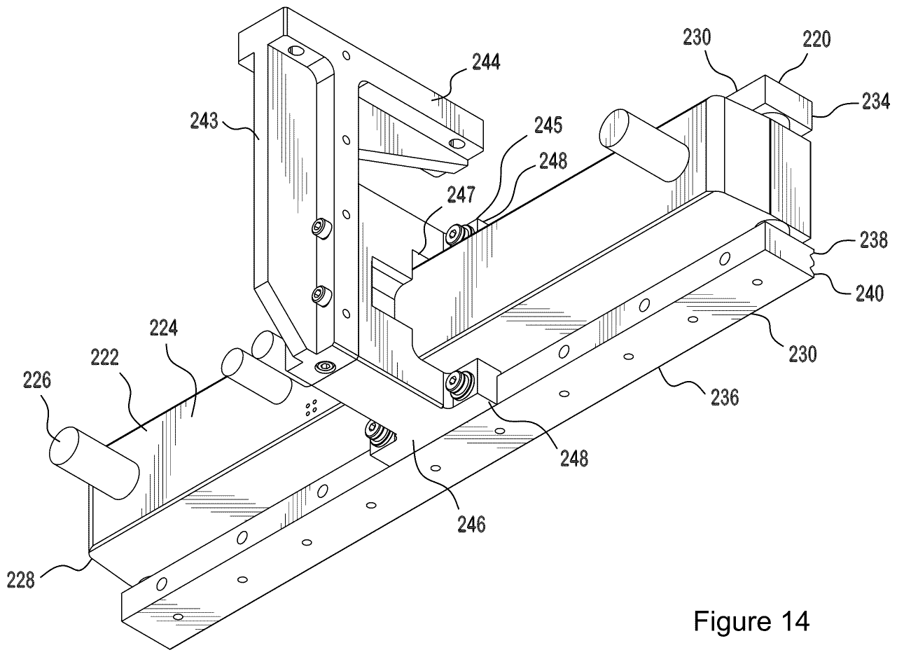

With reference to FIGS. 13 and 14, the plurality of guide rails 230 are shown and secured to outer surfaces of the drive modules 222. In the shown embodiment, each guide rail 230 is an elongated rectangular member extending along and secured to an outer surfaces of each drive module 222. As shown, the guide rail 230 follows the shape of the frame assembly 210 and each drive module 222.

In an exemplary embodiment of the invention, the guide rails 230 generally include a first guide rail 232 positioned on one side of the drive module 222 and a second guide rail 236 positioned on an opposite side of the drive module 222. Each guide rail 230 is positioned such that a top surface is substantially planar with the low friction guide surface 223 of the drive module 222.

More specifically, the first guide rail 232 is an elongated rectangular shaped member having a planar top surface 234 that is positioned substantially planar with the low friction guide surface 223 of the drive module 222. The second guide rail 236 is generally an elongated rectangular shaped member running parallel to the first guide rail 232. However, in contrast, the second guide rail 236 includes a pair grooves (an inner guide groove 238 and an outer guide groove 240) positioned on a top surface thereof. The inner guide groove 238 and the outer guide groove 240 are positioned substantially planar with the low friction guide surface 223 of the drive module 222 and run parallel to each other. The inner guide groove 238 and the outer guide groove 240 are identical v-shaped grooves in the shown embodiment. However, one skilled in the art would appreciate that other shapes and size configurations are possible within spirit of the invention.

As shown, the guide rails 230 are secured to the frame assembly 210 about the drive modules 222 using the plurality of guide rail brackets 242.

As shown in FIGS. 13 and 14, each guide rail bracket 242 includes a body 243 having a frame connection section 244, a first guide rail connection section 245, and a second guide rail connection section 246. As shown, the body 243 is a monolithic member made from a material having high strength, such as aluminum, steel or iron. However, one skilled in the art should appreciate other materials can be used.

According to the invention, the frame connection section 244 is positioned along one end of the body 243. In an exemplary embodiment, the frame connection section 244 is a planar body running transverse to the drive module 222 and the guide rails 230. As shown, the frame connection section 244 includes a support for strength and a plurality of fastener receiving passageways for securing the frame connection section 244 to the frame assembly 210 using fasteners.

According to the invention, the first guide rail connection section 245 and the second guide rail connection section 246 are positioned along another end of the body 243 with respect to the frame connection section 244. The first guide rail connection section 245 and the second guide rail connection section 246 are formed from a block member and separated from each other to provide a drive module receiving section 247 extending there through. The first guide rail connection section 245 and the second guide rail connection section 246 extend on either side of the u-shaped drive module receiving section 247 and include guide rail feet 248 that include a plurality of fastener receiving passageways for securing the first guide rail connection section 245 and the second guide rail connection section 246 to the first guide rail 232 and the second guide rail 236, respectively using fasteners.

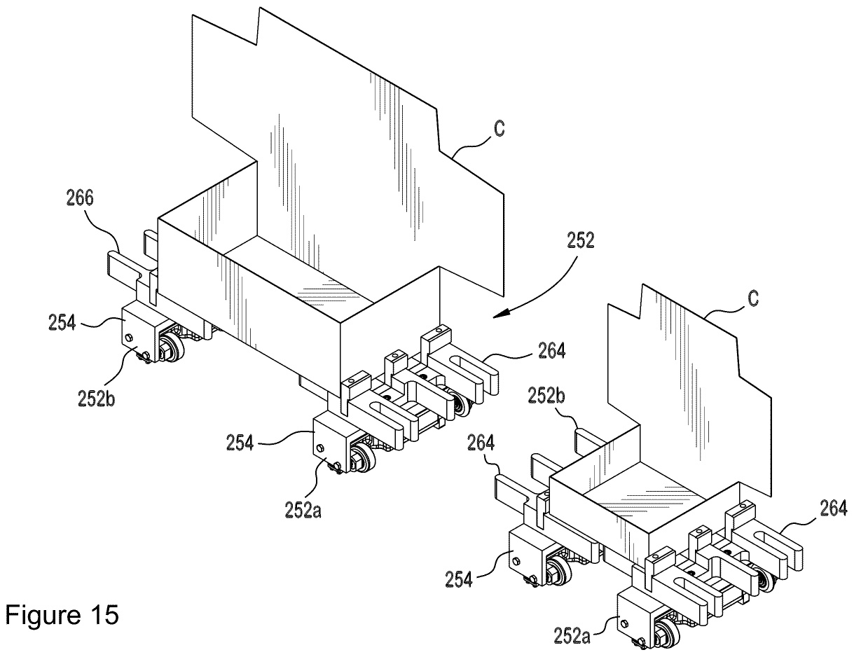

Now with reference to FIGS. 15-19, an exemplary embodiment of a transport vehicle 250 according to the invention is shown. The transport vehicle 250 generally includes a pair of shuttles 252 (a leading shuttle 252a and a trailing shuttle 252b spaced apart from each other).

As shown each shuttle 252 includes an upper body 254, an inner body 256, a pair of first guide rollers 258, a pair of second guide rollers 260, and a carrier assembly 264.

In an exemplary embodiment of the invention, the upper body 254 is a u shaped member having an upper planar surface 254a and a pair of ends 254b extending downward therefrom. The inner body 256 is a monolithic body positioned within a receiving space of the u-shaped body and secured to ends 254b of the upper body 254.

In an exemplary embodiment, as shown, the inner body 256 generally includes a body having magnet receiving space 256a for receiving a magnet 262, a cover 256b covering the magnet 262, and a pair of roller connection members 256c.

Each roller connection member 256c is a finger like member extending outward, from sides of the body to hold a pair of rollers (a pair of first guide rollers 258, a pair of second guide rollers 260). Each roller connection member 256c, on a single side, is offset from a corresponding roller connection member 256c along an axis (L) in the embodiment shown. In the embodiment shown, each roller connection member 256c is s-shaped. However, one skilled in the art should appreciate that other design and shape configurations are possible within spirit of the invention.

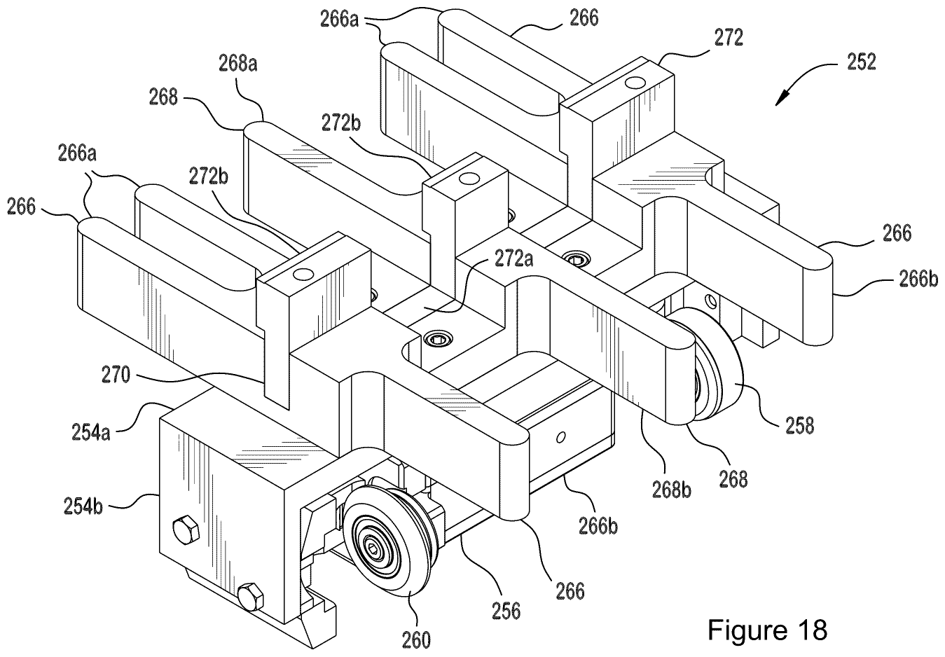

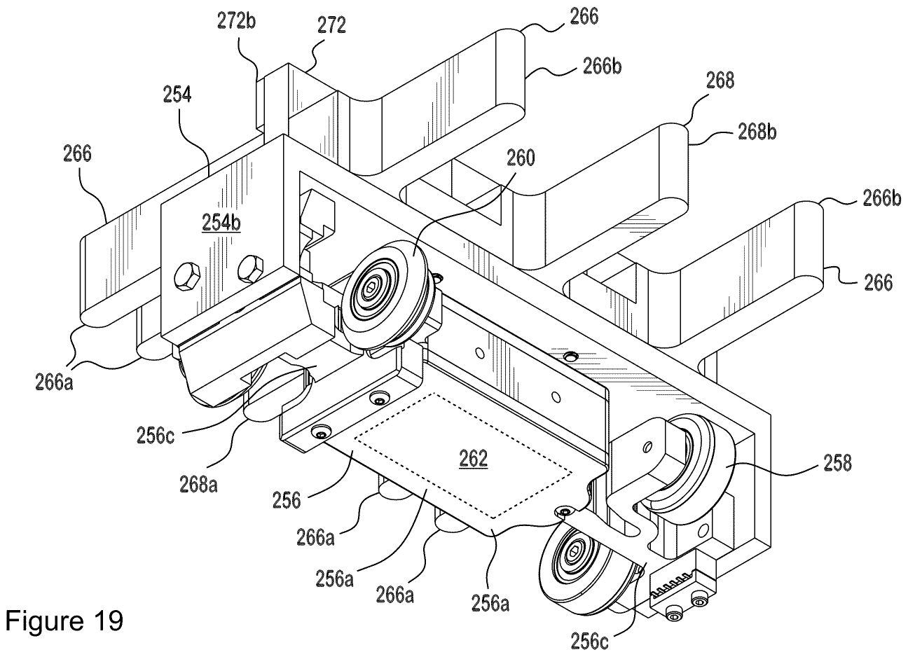

As shown in FIGS. 18 and 19, an exemplary embodiment of a carrier assembly 264 according to the invention is shown. The carrier assembly 264 is positioned on and secured to the upper planar surface 254a of the upper body 254. In an exemplary embodiment, the carrier assembly 264 is a monolithic body with a pair of first carrier sections 266, a second carrier section 268 and a holding block receiving space 270.

In the embodiment shown, each first carrier section 266 generally includes a pair of leading extension members 266a and a trailing extension member 266b extending outward a center thereof. More particularly, the first carrier section 266 is fork shaped with the trailing extension member 266b extending in an opposite direction from the pair of leading extension members 266a. The trailing extension member 266b is a single finger like member extending outward from a center thereof, while the pair of leading extension members 266a are a pair of finger like members extending outward from a center thereof. The pair of leading extension members 266a are u-shaped in the embodiment shown, with a trailing extension member receiving space 266c there between. The trailing extension member receiving space 266c is shaped and sized to correspond with a trailing extension member 266b of an adjacent shuttle 252 (i.e. a leading shuttle 252a or a trailing shuttle 252b)

In the embodiment shown, the second carrier section 268 generally includes a front extension member 268a, a rear extension members 268b extending from a center of the carrier assembly 264 and offset from the front extension member 268a. More particularly, the second carrier section 268 is s-shaped with the front extension member 268a extending in an opposite direction from the rear extension members 268b. The front extension member 268a is a single finger like member extending outward from a center thereof. Likewise, the rear extension member 268b is a finger like member that also extends outward from the center thereof, but in an opposite direction. In an exemplary, the front extension member 268a and the rear extension member 268b run parallel to each other but are offset such that a front extension member 268a of an adjacent shuttle 252 may be positioned adjacent to the rear extension member 268b, when shuttles 252 are stacked next to each other.

As shown, the holding block receiving space 270 is a groove extending through the monolithic body and runs transverse to the first carrier section 266 and the second carrier section 268. The holding block receiving space 270 is sized and shaped to receive and secure the holding block 272.

As further shown in FIGS. 18 and 19, an exemplary holding block 172 is shown and generally includes a support body 272a and plurality of stops 272b. The support body 272a is a plate like member that extends a width of the monolithic body of the carrier assembly 264 and is sized to fit and be secure in the holding block receiving space 270. Each stop 272b is a block like member that extends upward from the support body 272a and the first carrier sections 266 and the second carrier section 268. As shown, each stop 272b is a 1-shaped with opposing planar surfaces extending outward from a center thereof and corresponding with the first carrier section 266 or the second carrier section 268. However, one skilled in the art should appreciate that the other shapes and designs are possible in spirit of the invention. While the shown holding block 272 is made of separate pieces, one skilled in the art should appreciate that the holding block 272 could be a monolithic piece formed from a single piece of material, such as metal or a rigid plastic.

As assembled, the carrier assembly 264 is secured to the upper planar surface 254a of the upper body 254, while the inner body 256 is positioned between and secured to the pair of ends 254b of the upper body 254. The pair of first guide rollers 258 are positioned and secured to one side of the inner body 256, and the pair of second guide rollers 260 are positioned on an opposite of the inner body 256 as described above.

Now with reference to FIGS. 10-12, an exemplary unloading assembly 280 for a container shuttle assembly 200 according to the invention is shown. In an exemplary embodiment, the unloading assembly 280 is generally a plate like member positioned above the guideway 220 by a height HA slightly higher than a height HB of the transport vehicle 250 sitting on the guideway 220. However, as shown, the holding block 272 may be slightly positioned above unloading assembly 280 so that the holding block 272 can continue pushing the carton C along the unloading assembly 280 until the shuttle 252 arc away from unloading assembly as it continues along the guideway 220. The unloading assembly 280 generally includes a guide surface section 282 positioned on a trailing end there and a pair of leading outer arms 284 and a pair of leading inner arms 286 positioned on a leading end thereof. A plurality of guide support pieces 288 are provided to secure unloading assembly 280 to the frame assembly 210 and the guideway 220.

According to the invention, the container shuttle assembly 200 includes a guideway control system G that uses software, hardware, and electrical signals control movement of the transport vehicles 250 and, more particularly, the shuttles 252 by the drive modules 222 about the guideway 220. More particularly, the guideway control system G controls the position of a pair of shuttles 252 (a leading shuttle 252a and a trailing shuttle 252b spaced apart from each other by a specific distance). This can be performed by software known in the art for linear synchronous motor (LSM) systems, as adapted in accord with the teachings hereof, and, preferably, of the type described in the aforesaid incorporated-by-reference applications.

In an exemplary embodiment, the guideway control system G determines shuttle 252 presence and position by monitoring the position sensing logic (which may be, for example, magneto-electric, optical or otherwise) of the respective block and/or by monitoring vehicle identification logic (e.g., RFID or otherwise), also of the respective block. In some embodiments, position and/or identification information is determined in other ways, alternatively or in addition. Thus, for example, that information can be determined by inference, e.g., based on information supplied from other data processors (not shown).

With vehicle presence and position determined, the guideway control system G acquires velocity and acceleration set points for the shuttle 252 and then guideway control system G governs powering of the propulsion coils 226 that make up the drive module 222 and, thereby, governs the position, velocity and acceleration of transport vehicles 250 as they pass over that block—and, more specifically, the shuttles 252 over the respective propulsion coils 226 of that drive module 222. To this end, software determines where a shuttle 252 is on the guideway and powers the drive module 222 and propulsion coil 226 to re-position shuttle 252 to a specific position. This is done by receiving and applying control signals to the position sensing logic (sensors), power electronic components, and microprocessors 228 that serve as controllers for the propulsion coils 226.

Accordingly, a pair of shuttles 252 travel over the guideway 220 when the propulsion coils 226 is powered and provides a segmented electromagnetism field that interacts with the magnet 262 of the shuttle 252 to propel or stop the shuttle 252. As a result, the distance between the leading shuttle 252a and the trailing shuttle 252b can be managed. In fact, such a system allows for varied distance between the leading shuttle 252a and the trailing shuttle 252b, enabling the automatic size change means shown in FIGS. 10 and 11.

### Product Transport Assembly

Now with reference to FIGS. 1-21, a product transport assembly 300 according to the invention is shown. In an exemplary embodiment, the product transport assembly 300 generally includes a robot arm 310 with an end effector 312, a vision device 320, a conveyor belt 330, and a roller track 340.

The conveyor belt 330 extends parallel to the roller track 340. The conveyor belt 330 may be any type of powered belt known to those with ordinary skill in the art capable of being driven in a loop and moving an item placed on the belt along a length of the belt. The roller track 340, as shown, includes rollers 342 defining a receiving space for product P; the product P is movable along a length of the roller track 340.

The robot arm 310 and vision device 320, as shown, are positioned above the parallel conveyor belt 330 and roller track 340. The robot arm 310 is movable along all three axes of a three-dimensional coordinate system. The end effector 312 is fixed to an end of the robot arm 310 and is capable of directly interfacing with the product P. The end effector 312 is used to secure the product P to the robot arm 310 in a fixed orientation; the end effector 312 of the embodiment is not capable of tilting product P. In the shown embodiment, the end effector 312 is a suction. The end effector 312 could alternatively be fingers grasping the product P, pins penetrating the product P, a magnet forming an electromagnetic connection with the product P, a device attaching to the product P by adhesion, or any other type of end effector known to those with ordinary skill in the art.

The robot arm 310 and end effector 312 operate under guidance of the vision device 320, and in the shown embodiment, the vision device 320 is a camera. The camera has a resolution of at least 1080p and uses image recognition software to identify product P characteristics, such as size and orientation. In other embodiments, the vision device 320 may be a laser displacement sensor or any other type of vision device used in the guidance of robot arms and known to those with ordinary skill in the art.

### Positioning Management System

According to the invention, the container packaging assembly 1 includes a positioning management system 400 that communicates with the container forming assembly 100, the container shuttle assembly 200, and the product transport assembly 300; The positioning management system 400 generally includes known position sensors, signal and power electronics, and integrated software to control the container forming assembly 100, the container shuttle assembly 200, and the product transport assembly 300 in synchronicity. The positioning management system 400 communicates with the container forming assembly 100, the container shuttle assembly 200, and the product transport assembly 300 so that the container forming assembly 100 prepares the appropriate sized container for product C ready for packaging. The container shuttle assembly 200 is directed to appropriately position shuttles 252 to accommodate the appropriate size container C by adjusting the distance between the shuttles 252 to form a transport vehicle 250. The positioning management system 400 then can instruct the product transport assembly 300 to position the appropriate amount of product P in the container C moved by the transport vehicle 250 along the guideway 220. Generally, the positioning management system 400 is a hub to control the varied components of the container packaging assembly 1. The system uses real-time feedback from sensors (e.g., optical or magneto-electric) and control algorithms to dynamically Euras operations, ensuring precise handling of varying container sizes.

### System Assembly

Now with reference to FIG. 1-21 do, assembly of the container packaging assembly 1 according to the invention will be described.

In the exemplary embodiment of the invention, the container forming assembly 100 is positioned at one end and one side of the container shuttle assembly 200. The product transport assembly 300 is positioned at another end of the container shuttle assembly 200 and positioned on an opposite side with respect to the container forming assembly 100. The positioning management system 400 can be positioned anywhere and is connected to the container forming assembly 100, the container shuttle assembly 200, and the product transport assembly 300 using cables (not shown).

### Operation of the Container Packaging Assembly

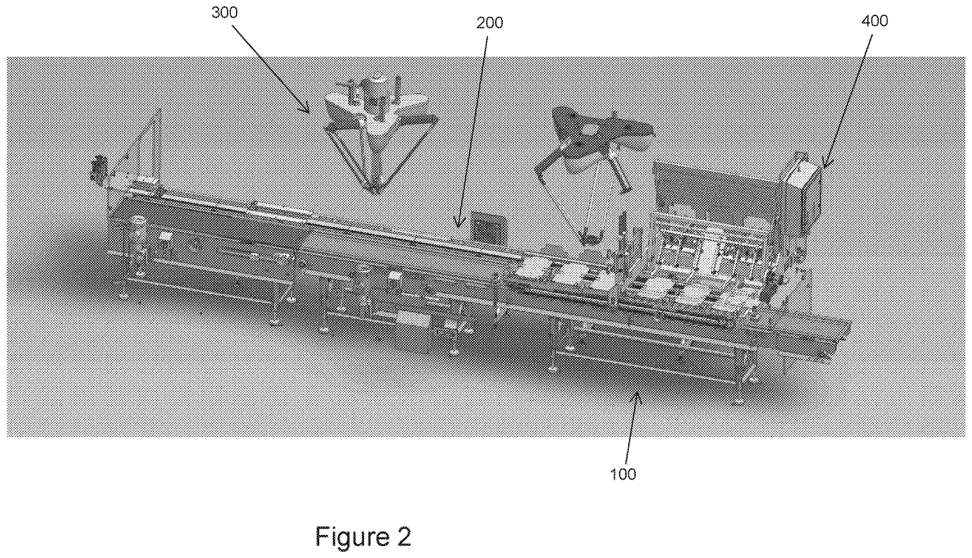

Now with reference to FIGS. 2-9, use of the container packaging assembly 1 will be described.

In an exemplary embodiment, the product transport assembly 300 identifies the type of product to be packaged using the vision device 320. The positioning management system 400 then commands the container forming assembly 100 to form specific sized containers based on a programmed setting as well as based on the product to be packaged.

The container forming assembly 100 operates as follows: The magazine 110 is filled with carton blanks to maintain sufficient back pressure, driving the blanks forward to carton gates for picking. The transferring mechanism 130 picks one to four blanks from the carton gates, depending on the single, double, triple, or quadruple cartridge configuration, and places them onto the stationary carton shuttle of the blank transport assembly 160 in a direction perpendicular to the magazine's flow. Four sets of servo-driven lugs capture the blanks at their corners, ensuring precise positioning. The carton shuttle indexes the blanks downstream, passing under the hot melt glue nozzles of the adhesive assembly 180, which apply adhesive to the major flaps of the blanks. At the forming station, the robot arm 166 with the plunger EOAT presses the blanks through an interchangeable forming die, folding and compressing the flaps to form tri-seal cartons with a base and vertical cover flap. The plunger EOAT holds the formed cartons with vacuum and places them into the carriers of the container shuttle assembly 200. This perpendicular transfer reduces the number of glue applicators to a single set for multiple lanes and enhances accessibility for maintenance and die changes.

At the same time, the container shuttle assembly 200 receives the formed tri-seal cartons from the constructing assembly 165.

The positioning management system 400 commands the guideway control system G to position a pair of shuttles 252 to travel over the guideway 220.

At the same time, the positioning management system 400 commands the guideway control system G to position a pair of shuttles 252 to travel over the guideway 220 using the propulsion coils 226 through segmented electromagnetic fields that interact with the magnet 262 of the shuttle 252 to propel or stop the shuttle 252. As a result, the distance between the leading shuttle 252a and the trailing shuttle 252b can match the container C transferred from the container forming assembly 100. The container C is supported by the carrier assembly 264 and, more particularly, corresponding first carrier sections 266 and second carrier sections 268 of the leading shuttle 252a and the trailing shuttle 252b. Further, the container C is held by holding blocks 272 of the leading shuttle 252a and the trailing shuttle 252b.

When positioned, the leading shuttle 252a and the trailing shuttle 252b are positioned to form a transport vehicle 250 for that matches the size of the transported container C from the container forming assembly 100.

In the exemplary embodiment, the container shuttle assembly 200 receives the formed tri-seal cartons, which are placed into the carriers by the plunger EOAT.

In the exemplary embodiment, the container shuttle assembly 200, adjacent to the container forming assembly 100, permits the leading shuttle 252a and the trailing shuttle 252b to be positioned relative to each other, such that they leave a length of space exactly equivalent to the length of a container C. The distance is automatically adjusted based on the programmed settings for sized container C formed by the container forming assembly 100. This is referred to as an automatic size change means, as shown in FIGS. 10 and 11. This feature will allow the container shuttle assembly 200 and, more particularly, the distance between the leading shuttle 252a and the trailing shuttle 252b to match the container C size once that size is set by the positioning management system 400. The automatic size change means eliminates changeover time, and can also enable other functions such as multiple concurrent sizes (described as follows).

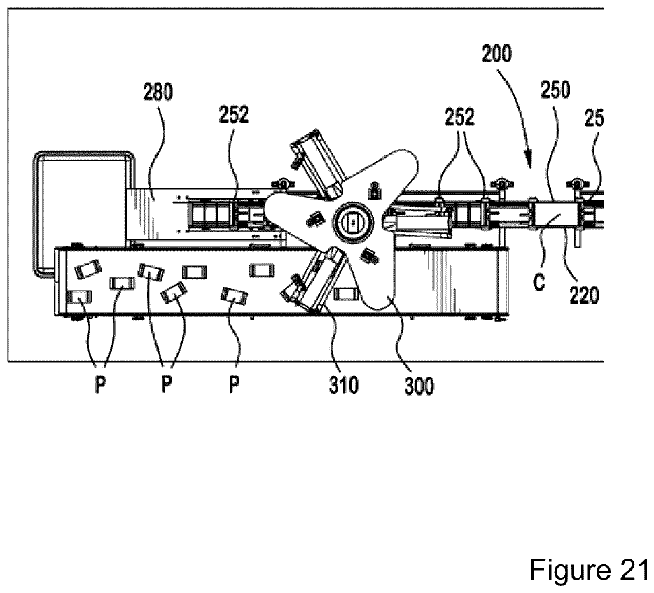

Further, the distance between containers C on the container shuttle assembly 200 is referred to as the “pitch”. In addition to the automatic size change functionality of the shuttles 252, the control over the independent shuttles 252 allows the container shuttle assembly 200 to automatically set the distance between each container along the guideway 220. The distance can be dynamically set to varying distances or all set the same, however the application is best serviced, and can be varied throughout the system as well. This feature is referred to as “variable pitch”, as illustrated in FIG. 21. This variable pitch means enables the process of moving containers C along the guideway 220 to be more efficient compared to a “fixed pitch” system. For a fixed pitch system the pitch would need to be large enough to fit the varying sized containers that cannot change. In this scenario the smaller containers C would be on the same pitch but have a large distance between them and therefore a less efficient process.

The container shuttle assembly 200 also has the capability of running different size containers C concurrently. As such, the positioning management system 400 commands the container forming assembly 100 to form varying sized containers C in a programmed sequential order. As the containers C are transported to the guideway 220, the container shuttle assembly 200 uses the auto-size adjustment means and the variable pitch means to adjust the shuttles 252 to position the leading shuttle 252a and the trailing shuttle 252b to adjust a distance there between to match the length of the transported container C. Additionally, the container shuttle assembly 200 adjusts the distance between the transport vehicles 250, enabling concurrent handling of multiple container sizes, as shown in FIGS. 15-17.

As the container C moves down the guideway 220 by the transport vehicle 250, the positioning management system 400 provides commands to product transport assembly 300 to identify the product P coming down the conveyor belt 330 using the vision device 320, and have the robot arm 310 place the appropriate amount of product P in the container C.

Expanding on the multiple concurrent sizes capability of the container shuttle assembly 200, the container packaging assembly 1 provides inspection of the incoming product to be loaded into the containers C and, based on this information, requests, on demand, the positioning management system 400 manages the appropriate container for this particular product or quantity of flow, as controlled by the system.

After the container C is loaded, the transport vehicle 250 moves the container C to the unloading assembly 280. The transport vehicle 250 travels under the unloading assembly 280, the pair of leading outer arms 284 support the container C, which further advances over the pair of leading inner arms 286, and transfers across the guide surface section 282 for further packaging (i.e. sealing) and shipping.

The container packaging assembly 1 is designed to handle potential failure modes, such as blank misalignments or jams, through real-time monitoring by the positioning management system 400. For example, if a blank is misaligned, the vision device 170 or 320 detects the issue, and the system pauses the affected assembly to allow correction, ensuring robust operation.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

1. An adaptive container packaging assembly, comprising:
a container forming assembly, the container forming assembly includes a main frame, the main frame houses a magazine, the magazine includes a plurality of blanks;
a transferring mechanism coupled to the main frame, the transferring mechanism includes an arm that is rotatably coupled between a width of a main frame, a beam extends across an upper region of the arm, the transferring mechanism includes a plurality of plunger assemblies coupled to the beam; and
a blank transport assembly positioned along a width of the main frame, wherein the transferring mechanism transports an unformed blank from the plurality of blanks in the magazine to the blank transport assembly, the transferring mechanism positions the unformed blank perpendicular to a direction of a carton shuttle of the blank transport assembly, the unformed blank is transported and then positioned under a plurality of adhesive nozzles apply adhesive during indexing prior to a forming station while in an unformed state of the blank.

2. The adaptive container packaging assembly of claim 1, wherein a container shuttle assembly including a guideway and a plurality of transport vehicles, each transport vehicle configured to adjust a distance between shuttles to accommodate varying container sizes.

3. The adaptive container packaging assembly of claim 2, wherein a product transport assembly configured to load product into containers on the container shuttle assembly.

4. The adaptive container packaging assembly of claim 3, wherein a positioning management system is configured to synchronize the container forming assembly, container shuttle assembly, and product transport assembly to handle varying container sizes.

5. (canceled)

6. The adaptive container packaging assembly of claim 1, wherein each plunger assembly includes a handle member.

7. The adaptive container packaging assembly of claim 6, wherein the handle member further houses at least one vacuum element.

8. The adaptive container packaging assembly of claim 7, wherein the vacuum element includes a body coupled to a flexible bellows made of a resilient material, configured to form a seal with the blank.

9. The adaptive container packaging assembly of claim 8, wherein the adaptive container packaging assembly further comprises a movement assembly.

10. The adaptive container packaging assembly of claim 9, wherein the movement assembly further includes an upper rotation member and a lower rotation member.

11. The adaptive container packaging assembly of claim 10, wherein the upper rotation member is coupled to the main frame.

12. The adaptive container packaging assembly of claim 11, wherein the lower rotation member is coupled to the upper rotation member and the transferring mechanism.

13. (canceled)

14. The adaptive container packaging assembly of claim 12, wherein the assembly further comprises a constructing assembly.

15. The adaptive container packaging assembly of claim 14, wherein the constructing assembly includes a robot arm with a plunger end-of-arm tool (EOAT) configured to press the blank through an interchangeable forming die to form a tri-seal carton.

16. The adaptive container packaging assembly of claim 15, wherein the robot and plunger EOAT are positioned above the carton shuttle.

17. The adaptive container packaging assembly of claim 16, wherein the adaptive container packaging assembly further includes an adhesive assembly.

18. The adaptive container packaging assembly of claim 17, wherein the adhesive assembly includes a pair of stabilizers coupled to the main frame.

19. The adaptive container packaging assembly of claim 18, wherein the adhesive assembly further includes an adhesive cartridge.

20. The adaptive container packaging assembly of claim 19, wherein the adhesive assembly further includes a pair of hot melt glue nozzles configured to apply adhesive to major flaps of the blank during indexing.

21. The adaptive container packaging assembly of claim 20, wherein each hot melt glue nozzle is coupled to the adhesive cartridge.

22. A method of adaptively packaging containers using the assembly of claim 1, comprising:
reloading an unformed blank into a magazine within a main frame housing;
transferring the unformed blank through a transferring mechanism which coupled to a main frame, the transferring mechanism including a plurality of plunger assemblies, each plunger assembly having a vacuum element with a flexible bellows configured to form a seal with a blank and transfer the blank through a placement insert of the magazine;
placing the unformed blank in a perpendicular position to a direction of a carton shuttle of the blank transport assembly, the unformed blank is transported and then positioned under a plurality of adhesive nozzles applying adhesive during indexing prior to a forming station while in an unformed state of the blank;
forming a container from a blank using the container forming assembly;
adjusting a distance between shuttles of a transport vehicle in the container shuttle assembly to match the size of the formed container;
transporting the formed container along a guideway of the container shuttle assembly;
loading product into the container using a product transport assembly; and
synchronizing the container forming assembly, container shuttle assembly, and product transport assembly using a positioning management system to handle varying container sizes.

23. A container forming assembly for an adaptive container packaging system, comprising:
a main frame housing a magazine, the magazine including a plurality of cartridges, each cartridge configured to hold a plurality of blanks of varying sizes in a single, double, triple, or quadruple lane configuration;
a transferring mechanism coupled to the main frame, the transferring mechanism including a plurality of plunger assemblies, each plunger assembly having a vacuum element with a flexible bellows configured to form a seal with a blank and transfer the blank through a placement insert of the magazine;
a movement assembly including an upper rotation member and a lower rotation member, the movement assembly configured to rotate the transferring mechanism to position the blank perpendicular to a flow direction of the magazine;
the blank transport assembly including a stationary carton shuttle captures corners of the blank in an unformed state and index the blank perpendicular to the flow direction of the magazine to a forming station; and
an adhesive assembly including an adhesive cartridge and a pair of hot melt glue nozzles configured to apply adhesive to major flaps of the blank during indexing of the blank in the unformed state.
